(19) United States
(12) Patent Application Publication
(10) Pub. No.: US 2024/0186588 A1
(43) Pub. Date: Jun. 6, 2024

(54) Jelly-Roll Type Electrode Assembly and Secondary Battery Including Same

(71) Applicant: LG Energy Solution, Ltd., Seoul (KR)

(72) Inventors: Seongmo Koo, Daejeon (KR); Young Soo Kim, Daejeon (KR); Eun Ji Park, Daejeon (KR); Kwan Soo Lee, Daejeon (KR); Byeongjoon Lee, Daejeon (KR)

(73) Assignee: LG Energy Solution, Ltd., Seoul (KR)

(21) Appl. No.: 18/526,439

(22) Filed: Dec. 1, 2023

(30) Foreign Application Priority Data
Dec. 1, 2022 (KR) 10-2022-0165808
Aug. 11, 2023 (KR) 10-2023-0105397

(51) Int. Cl. H01M 10/0587; H01M 50/451; H01M 50/46

(52) U.S. Cl. CPC H01M 10/0587; H01M 50/451; H01M 50/46

(57) ABSTRACT

A jelly-roll electrode assembly includes first and second electrodes spaced apart from each other and helically arranged in a first direction around a winding axis of a central core of the assembly. A separator overlapping portion includes a first separator positioned adjacent an inner surface of a terminal end of the second electrode and extending in a second direction opposite the first direction toward the central core, and a second separator positioned adjacent a terminal end of the first separator and extending in the second direction opposite the first direction toward the central core. A loop portion in which the first and second separators are looped about each other in the central core to extend in the first direction around the first and second electrodes such that the second separator extends in both the first and second directions within the separator overlapping portion.

### CROSS-REFERENCE TO RELATED APPLICATIONS

The present application claims priority to Korean Patent Application No. 10-2022-0165808 filed in the Korean Intellectual Property Office on Dec. 1, 2022, and Korean Patent Application No. 10-2023-0105397 filed in the Korean Intellectual Property Office on Aug. 11, 2023, the entire contents of which are incorporated herein by reference.

### TECHNICAL FIELD

The present invention relates to a jelly-roll type electrode assembly and a secondary battery including the same, and more particularly, to a jelly-roll type electrode assembly including a separator overlapping portion and a cylindrical secondary battery including the same.

### BACKGROUND ART

For a cylindrical battery, a jelly-roll type electrode assembly is manufactured by rolling a long electrode having a prescribed width into a roll form. In a cylindrical battery manufactured by inserting such a jelly-roll type electrode assembly into a battery case, contraction/expansion of the electrode repeatedly occurs during charging and discharging of the battery. In particular, when a degree of contraction/expansion of the electrode assembly increases due to a tab located in a core of the jelly-roll type electrode assembly or a silicon-based active material added in a negative electrode, a pressure acting on a core part of the electrode assembly greatly increases.

As low-resistance/high-capacity designs become more popular, jelly-roll type electrode assemblies often include a plurality of tabs or a silicon-based active material. Accordingly, the possibility of deformation of the electrode assembly located in the core part according to contraction/expansion of the electrode assembly increases. In particular, when a separator located between the negative electrode and the positive electrode becomes damaged, the negative electrode and the positive electrode may directly contact each other, causing heat generation and potential ignition due to an internal short.

In order to solve the problems of separator damage and internal shorts caused by the deformation of the electrode assembly, it is necessary to protect the negative electrode and separator and minimize potential internal shorts.

### Technical Problem

The present invention relates to an improved jelly-roll type electrode assembly, and a secondary battery including the same.

The problem to be solved by the present invention is not limited to the above-mentioned problems, and other problems not mentioned will be apparently understood by one skilled in the art from the following description.

### Technical Solution

An exemplary embodiment of the present invention provides a jelly-roll type electrode assembly including first and second electrodes spaced apart from each other and helically arranged in a first direction around a winding axis of a central core of the assembly; a separator overlapping portion including: a first separator positioned adjacent an inner surface of a terminal end of the second electrode and extending in a second direction opposite the first direction toward the central core; a second separator positioned adjacent a terminal end of the first separator and extending in the second direction opposite the first direction toward the central core; and a loop portion in which the first and second separators are looped about each other in the central core to extend in the first direction around the first and second electrodes such that the second separator extends in both the first and second directions within the separator overlapping portion.

Another exemplary embodiment of the present invention provides a secondary battery including the jelly-roll type electrode assembly described above; and a battery case for accommodating such an electrode assembly.

Another exemplary embodiment of the present invention provides a method of assembling a jelly-roll electrode assembly, the method comprising: positioning a terminal end of a first separator adjacent to an outer electrode; looping a free end of the first separator in a first circumferential direction around a central core of the assembly such that the free end extends in a second circumferential direction away from the central core and opposite the first circumferential direction; positioning a terminal end of a second separator adjacent the terminal end of the first separator on a radially inward side of the first separator; looping a free end of the second separator in the first circumferential direction around the central core such that the free end extends in a second circumferential direction opposite the first circumferential direction and away from the central core; passing the free end of first separator in the second circumferential direction around a radially inward side of an inner electrode; and passing the free end of the second separator in the second circumferential direction around a radially outward side of the inner electrode such that the second separator extending in the second circumferential direction is adjacent the second separator extending in the first circumferential direction.

According to another exemplary embodiment of the present invention, a jelly-roll electrode assembly comprises: positive and negative electrodes; and a separator overlapping portion including a first separator positioned adjacent a second separator and extending in at least three layers in a first direction toward a core of the electrode assembly between an inner surface of the positive electrode and an outer surface of the negative electrode, the separator overlapping portion defining a first interface in which the second separator extending in the first direction and the second separator extending in a second direction opposite the first direction contact each other, and defining a second interface in which the second separator extending in the first direction and the first separator extending in the first contact each other.

### Advantageous Effects

The jelly-roll type electrode assembly according to an exemplary embodiment of the present invention includes a separator overlapping portion and a bending structure of a separator at a core part of the electrode assembly. A friction coefficient between interfaces can be controlled, thereby suppressing sliding of the electrode during charging and discharging of the battery, which prevents damage to the negative electrode and the separator if the electrode assembly deforms due to contraction/expansion of the electrode. In addition, even if the separator becomes damaged, the separator overlapping portion can prevent an internal short between the positive electrode and the negative electrode to improve the battery stability and the lifespan.

The effects of the present invention are not limited to the foregoing effects, and effects not mentioned will be apparently understood by one skilled in the art from the present specification and accompanying drawings.

### BRIEF DESCRIPTION OF DRAWINGS

FIG. 1 is a top view of a jelly-roll type electrode assembly including a separator overlapping portion according to an exemplary embodiment;

FIG. 2 is an enlarged top view of a portion of the assembly of FIG. 1;

FIG. 3 is a partially exploded top view of the separator overlapping portion within the assembly portion of FIG. 2;

FIG. 4 is a CT image showing results of short-term cycle stability evaluation for secondary batteries according to Example 1 and Comparative Example 1;

FIG. 5 is a partially exploded top view of a separator overlapping portion of the jelly-roll type electrode assembly according to an exemplary embodiment of the present invention;

FIG. 6 is a CT image showing results of short-term cycle stability evaluation for secondary batteries according to Examples 1 to 4.

FIG. 7 is a CT image showing results of long-term cycle stability evaluation for secondary batteries according to Example 1 and Comparative Example 1.

FIG. 8 is a graph showing results of long-term cycle stability evaluation for secondary batteries according to Example 1 and Comparative Example 1.

FIG. 9 is a partially exploded top view of the assembly of FIG. 1 in which a method for evaluating electrode damage is implemented;

### DETAILED DESCRIPTION OF THE PREFERRED EMBODIMENTS

Herein, when one part “includes”, “comprises” or “has” one constituent element throughout the present specification, unless otherwise specifically described, this does not mean that another constituent element is excluded, but means that another constituent element may be further included.

Throughout the present specification, when a member is referred to as being “on” another member, the member can be in direct contact with another member, or an intervening member may also be present.

An exemplary embodiment of the present invention provides a jelly-roll type electrode assembly in which a first separator, a negative electrode, a second separator, and a positive electrode are sequentially stacked and wound, wherein the positive electrode has a first surface in a direction of a winding axis of the jelly-roll type electrode assembly, and a second surface opposite to the first surface, wherein a core part of the electrode assembly includes a separator overlapping portion between the positive electrode and the negative electrode facing the first surface of the positive electrode, and wherein the separator overlapping portion includes the separators that are overlapped and arranged and are in three or more layers.

The jelly-roll type electrode assembly according to an exemplary embodiment of the present invention includes a separator overlapping portion, which is configured to suppress sliding of the electrode during charging and discharging of the battery to prevent damage to the negative electrode and the separator from deformation of the electrode assembly due to contraction/expansion of the electrode. In addition, even if the separator is damaged, the separator overlapping portion can prevent an internal short between the positive electrode and the negative electrode to improve the battery stability and lifespan. The ‘core part’ is a hollow region within the core and it defines a winding axis of the electrode assembly, and a part of a laminated structure of the wound first separator/negative electrode/second separator/positive electrode, and may refer to a region within 2 rotational turns of the positive electrode from one end portion, in the longitudinal direction, of the positive electrode located on the innermost side of the electrode assembly. In addition, “a turn” or “a rotational turn” may mean a length required to wind an electrode or separator included in an electrode assembly by 360° from a reference point, and the length may be determined depending on an outer diameter of a winding core used for winding the electrode assembly, a thickness of the electrode or separator, and the number of windings of the electrode or separator positioned on an inner side. For example, one turn of the positive electrode may mean a length required to wind the positive electrode by 360° from a longitudinal end portion of the positive electrode in a direction in which the jelly-roll type electrode assembly is wound, such a direction being either clockwise or counterclockwise.

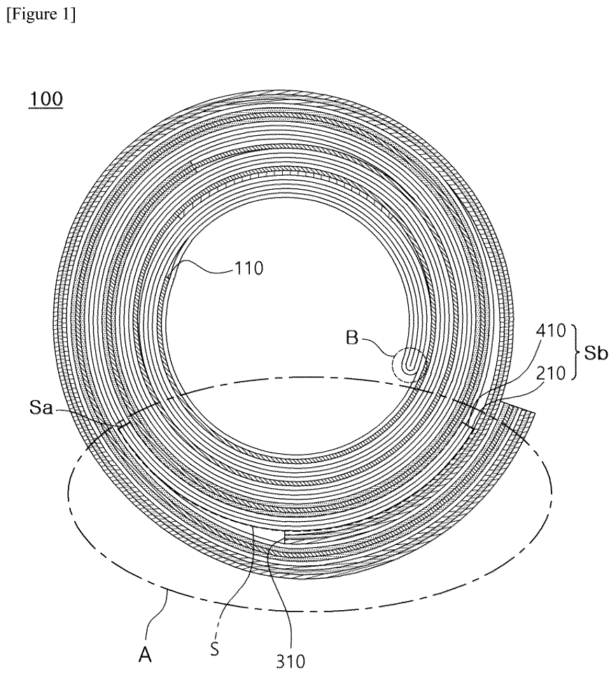

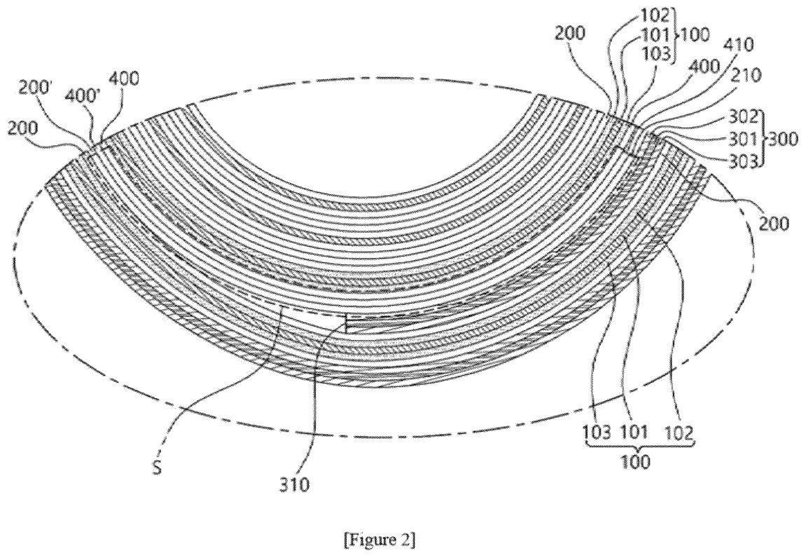

FIGS. 1 and 2 show a jelly-roll type electrode assembly including a separator overlapping portion according to an exemplary embodiment of the present invention. Specifically, FIG. 1 shows a jelly-roll type electrode assembly including a separator overlapping portion according to an exemplary embodiment of the present invention, and FIG. 2 is an enlarged view of a part A of FIG. 1.

According to an exemplary embodiment of the present invention, illustrated in FIGS. 1 and 2, the first separator 200, the negative electrode 100, and the second separator 400 may extend longer than a longitudinal end portion 310 of the positive electrode. That is, the first separator, the negative electrode, and the second separator are initially wound together, and then the positive electrode 300 may start at longitudinal end portion 110 and be wound with the first separator 200, negative electrode 100, and second separator 400. For example, after the first separator, the negative electrode, and the second separator are wound at least one turn around a winding core, the first separator, the negative electrode, and the second separator may be wound together with the positive electrode. As such, near the core part of the jelly-roll type electrode assembly, longitudinal end portions 210, 110, and 410 of the first separator, the negative electrode, and the second separator, respectively, may be positioned on radially inner sides of longitudinal end portion 310 of the positive electrode 300. In other words, the negative electrode 100 may have larger dimensions i.e., length and width, than those of the positive electrode 300, and lengths and widths of the first separator and the second separator may also be greater than those of the positive electrode 300. When the first separator, the negative electrode, and the second separator extend longer than the longitudinal end portion of the positive electrode, lithium ions can be more easily transferred from the positive electrode to the negative electrode in a chemical reaction of the lithium-ion battery. When the dimensions of the negative electrode are larger, the surface area of the negative electrode configured to receive lithium ions increases to prevent a decrease in charge/discharge efficiency and to improve the battery stability and the lifespan.

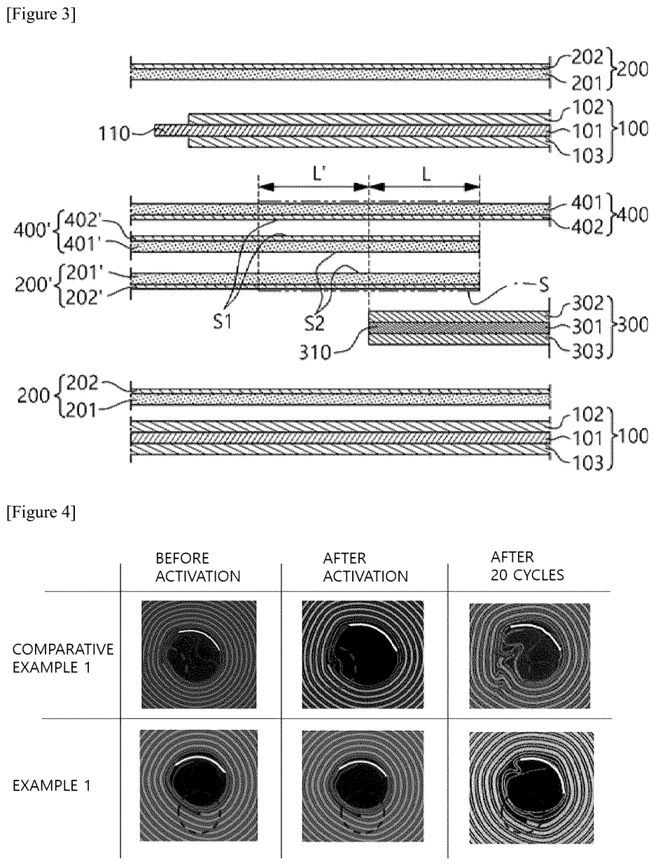

FIG. 3 schematically shows the separator overlapping portion of the jelly-roll type electrode assembly according to an exemplary embodiment of the present invention.

According to an exemplary embodiment of the present invention, the core part of the electrode assembly may include a separator overlapping portion between the positive electrode and the negative electrode facing a first surface of the positive electrode, and the separator overlapping portion includes the separators that are overlapped and arranged and are in three or more layers.

Specifically, referring to FIGS. 1 to 3, the separator overlapping portion S between the positive electrode 300 and the negative electrode 100 facing a radially inner surface of the positive electrode 300, and the separator overlapping portion S may refer to a part of a region in which the separators that are overlapped and arranged in three or more layers, with respect to the longitudinal end portion 310 of the positive electrode 300. The separator overlapping portion S may refer to a region having one circumferential end Sₐ defined at a location where the presence of the three or more abutting layers of the separator terminates. The separator overlapping portion S may extend from that circumferential end Sₐ along those three abutting layers of separator to an opposing circumferential end S_{b}, where the opposing circumferential end S_{b} is defined by a location spaced away from the longitudinal end portion 310 of the positive electrode 110 by the same length that the one circumferential end Sₐ is spaced away from the longitudinal end portion 310.

Specifically, the separator overlapping portion S may refer to a region extending between the one circumferential end Sₐ, which is spaced by a length L from the longitudinal end portion 310 of the positive electrode 300, to a point that is spaced by a length L′ in the opposite circumferential direction beyond the longitudinal end portion 310, where the length L is equal to the length L′. That is, the separator overlapping portion S is a region having a length (L+L′=L+L=2L) from the longitudinal end portion 310 of the positive electrode 300.

According to an exemplary embodiment of the present invention, the first separator and the second separator may extend from a longitudinal end portion 110 of the negative electrode 100 near the core part C of the electrode assembly through the separator overlapping portion S. In some embodiments, the first separator 200 and the second separator 400 may extend past the longitudinal end portion 110 of the negative electrode further into the core part. Continuing with this exemplary embodiment, the first separator 200 and the second separator 400 are wound by a predetermined length in a winding direction, and then they may be wound together with the negative electrode 100 along the winding direction. That is, the first separator 200′ and the second separator 400′ extending from the longitudinal end portion 110 of the negative electrode may include the first separator 200′ and the second separator 400′ extending opposite to the winding direction. Such a bending and overlapping of separator forms the separator overlapping portion S. The separator overlapping portion can be formed by bending the first and second separators 200, 400 around each other within the core C such that an additional auxiliary separator is not needed within the separator overlapping portion S. Such an arrangement allows the separator overlapping portion to include three or more layers formed by two distinct separators 200, 400. In addition, when the separator overlapping portion is formed by overlapping the first separator 200 and the second separator 400 to extend from the longitudinal end portion 110 of the negative electrode 100, it is possible to prevent damage to the negative electrode and the separator from deformation of the electrode assembly due to contraction/expansion of the electrode. In addition, even if the separator is damaged, the separator overlapping portion can prevent an internal short by preventing the positive electrode 300 and the negative electrode 100 from contacting each other, so as to improve the battery stability and the lifespan.

According to an exemplary embodiment of the present invention, the first separator and the second separator 200, 400 may extend in a first direction from the longitudinal end portion 110 of the negative electrode 100 at the core part C of the electrode assembly, may be bent together in an opposite second direction opposite to face a winding axis of the negative electrode, and may be overlapped and arranged between the positive electrode 300 and the second separator 400 facing the radially inner surface of the positive electrode 300, so as to form the separator overlapping portion S between the positive electrode 300 and the negative electrode 100 that faces the radially inner surface of the positive electrode 100. Through this, it is possible to more easily control the facing direction of the separators constituting the separator overlapping portion while allowing the separators constituting the separator overlapping portion to include three or more layers by the simple bending structure.

According to an exemplary embodiment of the present invention, the separator overlapping portion may include a first interface S1 at which the second separator 400 and the second separator 400′ are in direct contact with each other, and a second interface S2 at which the second 400′ separator and the first separator 100′ are in direct contact with each other. Specifically, referring to FIG. 3, the separator overlapping portion S may include the separators that are overlapped and arranged in three or more layers, may include one or more of each of the first separators 200 and 200′ and the second separators 400 and 400′, and may include a first interface S1 at which the second separator 400 and the second separator 400′ are in direct contact with each other, and a second interface S2 at which the second separator 400′ and the first separator 200′ are in direct contact with each other. Since the separator overlapping portion includes the plurality of interfaces, it is possible to easily control the direction the separators are facing, which in turn allows the coefficient of friction between the interfaces to be controlled due to the bending structure of the separators.

According to an exemplary embodiment of the present invention, the first interface S1 and the second interface S2 each may have a friction coefficient of 0.4 or greater. Specifically, referring to FIG. 3, the friction coefficients of the first interface S1 and the second interface S2 may be 0.42 or greater, 0.44 or greater, or 0.46 or greater. In other words, the separator overlapping portion S includes the overlapping structure of the plurality of separators such as the first separator and the second separator, rather than an overlapping structure of a single separator, and includes a plurality of interfaces at each of which the separators contact each other. Thus, the friction coefficients of the plurality of interfaces may be each controlled. When the friction coefficients of the first interface and the second interface satisfy the above ranges, it is possible to suppress the sliding of the positive electrode by the first separator and the second separator integrally formed with the separator overlapping portion during charging and discharging of the battery, and to prevent damage to the negative electrode and the separator from deformation of the electrode assembly due to contraction/expansion of the electrode. Here, the friction coefficient (u) may refer to a static friction coefficient measured in accordance with the ASTM D 1894 standard. Such a coefficient may be measured in a dry method, and may have a larger value when measured by a wet method of immersing a specimen in distilled water or an electrolyte solution.

According to an exemplary embodiment of the present invention, the friction coefficient of the first interface may be 0.6 or greater, and the friction coefficient of the second interface may be 0.4 or greater. Specifically, referring to FIG. 3, the friction coefficients of the first interface S1 and the second interface S2 may be different from each other based on the type and orientation of the first and second separators 200, 200′, 400, 400′ within the first and second interfaces S1, S2. More specifically, the friction coefficient of the first interface S1 may be 0.62 or greater, 0.64 or greater, or 0.66 or greater, and the friction coefficient of the second interface S2 may be 0.42 or greater, 0.44 or greater, or 0.46 or greater. When the friction coefficients between the interfaces of the separators included in the separator overlapping portion are controlled within such ranges, it is possible to suppress the sliding of the electrode during charging and discharging of the battery, and to prevent damage to the negative electrode and the separator from deformation of the electrode assembly due to contraction/expansion of the electrode. In addition, even if the separator is damaged, the separator overlapping portion can prevent an internal short between the positive electrode and the negative electrode to improve the battery stability and the lifespan.

According to an exemplary embodiment of the present invention, a jelly-roll type electrode assembly may include a plurality of separators. For example, the jelly-roll type electrode assembly may have a structure in which a first separator/a negative electrode/a second separator/a positive electrode are sequentially stacked. The separators 200 and 400 serve to separate the negative electrode 100 and the positive electrode 300 and to provide a movement path of lithium ions, in which a variety of separators known in the art may be used, and particularly, a separator having high moisture-retention ability for an electrolyte as well as a low resistance to the movement of electrolyte ions. Specifically, a porous polymer film, for example, a porous polymer film manufactured from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. In addition, a typical porous non-woven fabric, for example, a non-woven fabric formed of high melting point glass fibers, polyethylene terephthalate fibers, or the like may be used. In addition, the separator may typically have a thickness of 10 μm or more and 20 μm or less. A separator in which the above-described separator material is used as a base layer and a slurry containing a ceramic component or a polymer material so as to secure heat resistance or mechanical strength is coated on the base layer may be used. The separator having a single layer or multilayer structure may be selectively used.

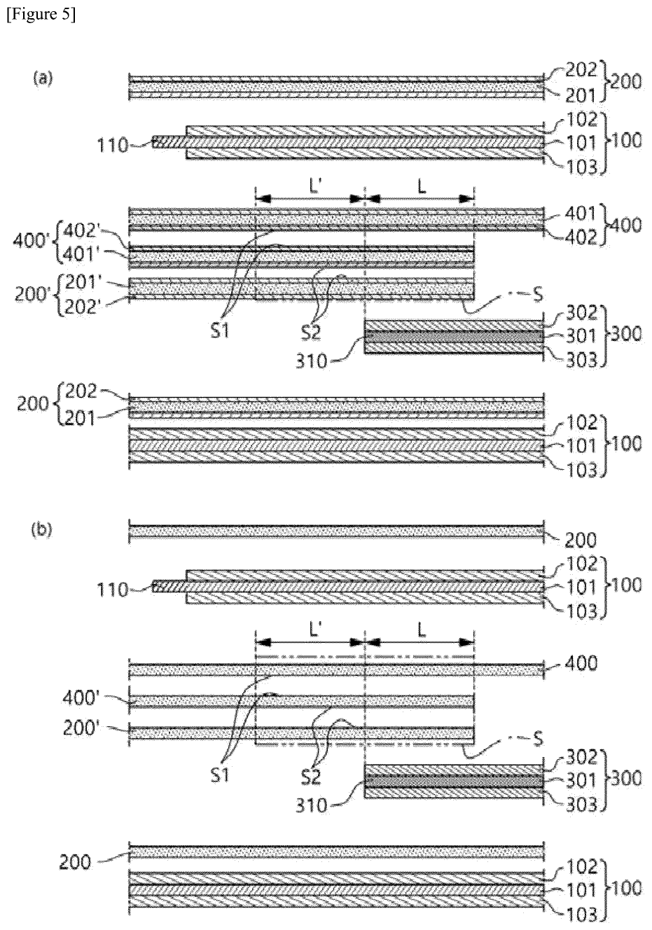

FIG. 5 schematically shows a separator overlapping portion of the jelly-roll type electrode assembly according to an exemplary embodiment of the present invention. Specifically, FIG. 5(a) schematically shows a separator overlapping portion of a jelly-roll type electrode assembly including a first separator and a second separator each having coating layers on both surfaces, and FIG. 5(b) schematically shows a separator overlapping portion of a jelly-roll type electrode assembly including a first separator and a second separator without a coating layer.

According to an exemplary embodiment of the present invention, each of the first separator 200 and the second separator 400 may include a coating layer provided on at least one surface thereof. Specifically, referring to FIGS. 3 and 5(a), the first separators 200 and 200′ and the second separators 400 and 400′, where the prime number indicates the same separator is extending in an opposite direction to the winding direction due to the bending structure of the separators at the bend point B, may include the coating layers 202, 202′, 402 and 402′ provided on at least one surface thereof, respectively, and the base layers 201, 201′, 401 and 401′ may each have a friction coefficient within a specific range by controlling a component, a content, and a particle size of the coating layer. Specifically, a friction coefficient between the coating layer and the coating layer and a friction coefficient between the base layer and the base layer of the separator may be greater than a friction coefficient between the coating layer and the base layer. The friction coefficients may be measured in a dry method, but may have a more significant difference when immersed in distilled water or an electrolyte solution, i.e., when measured in a wet method.

When the coating layer is provided on at least one surface of each of the first separator 200 and the second separator 400, the friction coefficient between the interfaces of the separators included in the separator overlapping portion is controlled to a specific range by controlling the facing direction of the coating layers to suppress the sliding of the electrode during charging and discharging of the battery, and to prevent damage to the negative electrode and the separator from deformation of the electrode assembly due to contraction/expansion of the electrode.

According to an exemplary embodiment of the present invention, each of the first separator 200 and the second separator 400 may include a coating layer provided on at least one surface thereof, and the coating layer may include an inorganic component, a binder component, and a lithium salt. With such components, an increase in internal resistance is achieved, but such increase is not caused by the elution of the lithium salt contained in the coating layer, despite the fact that the binder for improving adhesion with the electrode and the inorganic component for improving the mechanical strength of the separator is included. Thus, the result is improved cell stability.

Since the electrolyte solution impregnation level of the electrode facing the separator can be increased, the electrode assembly's lifespan can be increased. Specifically, the coating layer 202, 202′, 402, 402′ may include the inorganic component, and the coating layer including the inorganic component is advantageous in terms of thermal shrinkage, as compared with a separator made of a simple polymer material. Therefore, the separator including the inorganic component may be safer at higher temperatures.

The lithium salt may be substantially the same as that contained in an electrolyte solution of a lithium secondary battery, and may be, for example, at least one selected from the group consisting of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂) 2NLi, lithium chloroborane, lithium lower aliphatic carboxylate, and lithium tetraphenyl borate.

The inorganic component can be made from a variety of materials so long as the materials do not cause oxidation and/or reduction reactions, i.e., an electrochemical reaction with a positive electrode or negative electrode current collector within an operating voltage range of the battery (e.g., 0 to 5 V based on Li/Li⁺), and does not impair conductivity. Such materials may be, for example, at least one material selected from the group consisting of BaTiO₃, Pb(Zr,Ti)O₃(PZT), Pb₁₋ₓLaₓZr_{1-y}Ti_{y}O₃(PLZT), Pb(Mg₃Nb_{2/3})O₃⁻PbTiO₃(PMN-PT), hafnia (HfO₂), SrTiO₃, SnO₂, CeO₂, MgO, NiO, CaO, ZnO, ZrO₂, Y₂O₃, Al₂O₃, and TiO₂.

The binder may be made from a variety of materials so long as it is not easily dissolved by the electrolyte solution while exhibiting a bonding force between an electrode stacked on the separator, an inorganic component and a lithium salt in the mixed coating layer. For example, the binder may be at least one of the materials selected from the group consisting of polyvinylidene fluoride (PVdF); polyvinylidene fluoride-co-hexafluoropropylene; polyvinylidene fluoride-co-trichloroethylene; polyvinylidene fluoride chlorotrifluoroethylene(PVdF-CTFE); polymethyl methacrylate; polyacrylonitrile; polyvinylpyrrolidone; polyvinylacetate; polyethylene-co-vinylacetate copolymer; polyethyleneoxide; cellulose acetate; cellulose acetate butyrate; cellulose acetate propionate; cyanoethyl pullulan; cyanoethyl polyvinyl alcohol; cyanoethyl cellulose; cyanoethyl sucrose; pullulan; carboxylmethyl cellulose; acrylonitrile-styrene-butadiene copolymer; and polyimide, and preferably may be PVdF or PVdF-CTFE.

According to an exemplary embodiment of the present invention, the first separator 200 and the second separator 400 may each include a coating layer provided on at least one surface thereof, and the surfaces of the first separator 200 and the second separator 400 provided with the coating layer may have a friction coefficient greater than that of surfaces of the first separator 200 and the second separator 400 not provided with a coating layer. Specifically, referring to FIG. 3, the first separators 200 and 200′ and the second separators 400 and 400′ may have coating layers 202, 202′, 402 and 402′ provided on one surface, respectively. In addition, the surface of the first separator and the second separator provided with the coating layer may have a greater friction coefficient than the surface of the first separator and the second separator not provided with a coating layer. That is, the coating layer may increase the friction coefficient of the interface when provided on the separator. The friction coefficient between the interfaces of the separators included in the separator overlapping portion is controlled to a specific range by controlling the facing direction of the coating layers provided on one surface of each of the first separator and the second separator, to suppress the sliding of the electrode during charging and discharging of the battery, and to prevent damage to the negative electrode and the separator from deformation of the electrode assembly due to contraction/expansion of the electrode.

According to an exemplary embodiment of the present invention, each of the first separator and the second separator may include a coating layer provided on one surface thereof. Specifically, referring to FIG. 3, the first separators 200 and 200′ and the second separators 400 and 400′ may include the coating layers 202, 202′, 402 and 402′ provided on one surface thereof, and the base layer 201, 201′, 401 and 401′, respectively, and may each have a friction coefficient within a specific range by controlling a component, a content, and a particle size of the coating layer.

When a coating layer is provided on one surface of each of the first separator and the second separator, the friction coefficient between the interfaces of the separators included in the separator overlapping portion is controlled to a specific range by controlling the facing direction of the coating layers provided on one surface of each of the first separator and the second separator. Controlling the orientation of the such separators and coating layers suppresses the sliding of the electrode during charging and discharging of the battery, and prevents damage to the negative electrode and the separator from deformation of the electrode assembly due to contraction/expansion of the electrode.

According to an exemplary embodiment of the present invention, the first separator and the second separator may each include a coating layer provided on one surface thereof, and the first interface may be an interface at which the coating layer of the second separator and the coating layer of the second separator are in direct contact with each other. Specifically, referring to FIG. 3, the first separators 200 and 200′ and the second separators 400 and 400′ may have coating layers 202, 202′, 402 and 402′ provided on one surface thereof, respectively, and the first interface (S1) may be an interface at which the coating layer 402 of the second separator and the coating layer 402′ of the second separator are in direct contact with each other. When the coating layers of the second separator are in direct contact with each other, the friction coefficient between the coating layers of the separator may be greater than the friction coefficient between the base layer and the base layer or the friction coefficient between the coating layer and the base layer, and the friction coefficient of the first interface may have a larger value than such other coefficients. When the coating layer of the second separator 400 and the coating layer of the second separator 400′ are in direct contact at the first interface, the friction coefficient between the interfaces of the separators included in the separator overlapping portion is higher, such that it is possible to suppress the sliding of the electrode during charging and discharging of the battery, and thus, to prevent damage to the negative electrode and the separator from deformation of the electrode assembly due to contraction/expansion of the electrode.

According to an exemplary embodiment of the present invention, the first separator 200 and the second separator 400 may each include a coating layer provided on one surface thereof, and the second interface S2 may be an interface at which a surface of the second separator 400 not provided with a coating layer and a surface of the first separator 200 not provided with a coating layer are in direct contact with each other. Specifically, referring to FIG. 3, the first separators 200 and 200′ and the second separators 400 and 400′ may have coating layers 202, 202′, 402 and 402′ provided on one surface thereof, respectively, and the second interface (S2) may be an interface at which a surface of the second separator not provided with a coating layer, i.e., the second separator base layer 401′, and a surface of the first separator not provided with a coating layer, i.e., the first separator base layer 201′ are in direct contact with each other. When a surface of the second separator 400 not provided with a coating layer and a surface of the first separator not provided with a coating layer are in direct contact with each other, the friction coefficient between the base layer and the base layer of the separator may be greater than the friction coefficient between the coating layer and the base layer, and the friction coefficient of the second interface may be larger. When the uncoated surface of the second separator 400 not provided with a coating layer and the uncoated surface of the first separator 200 not provided with a coating layer are in direct contact with each other at the second interface, the friction coefficient between the interfaces of the separators included in the separator overlapping portion is higher, such that it is possible to suppress the sliding of the electrode during charging and discharging of the battery, and thus, to prevent damage to the negative electrode and the separator from deformation of the electrode assembly due to contraction/expansion of the electrode.

According to an exemplary embodiment of the present invention, the first interface may be an interface at which the second separator facing the radially inner surface of the positive electrode and the second separator extending from the longitudinal end portion of the negative electrode at the core part of the electrode assembly are in direct contact with each other. Specifically, referring to FIGS. 1 to 3, the second separator 400′ extending from the longitudinal end portion 110 of the negative electrode may be overlapped to form the separator overlapping portion S between the positive electrode 300 and the negative electrode 100 facing the radially inner surface of the positive electrode. Because the second separator 400 is positioned between the positive electrode 300 and the negative electrode 100 facing the radially inner surface of the positive electrode, the extended second separator 400′ may be in direct contact with the second separator 400 positioned between the positive electrode 300 and the negative electrode 100. That is, the first interface S1 at which the second separator 400 and the second separator 400′ extending from the longitudinal end portion 110 of the negative electrode at the core part of the electrode assembly contact each other. Through this, it is possible to more easily control the facing direction of the separators constituting the separator overlapping portion and the frictional force at the interface while allowing the separators constituting the separator overlapping portion to include at least three layers by the simple bending structure.

According to an exemplary embodiment of the present invention, the second interface may be an interface at which the first separator extending from the longitudinal end portion of the negative electrode at the core part of the electrode assembly and the second separator extending from the longitudinal end portion of the negative electrode at the core part of the electrode assembly contact each other. Specifically, referring to FIGS. 1 to 3, the first separator 200′ extending from the longitudinal end portion 110 of the negative electrode and the second separator 400′ extending from the longitudinal end portion of the negative electrode may be overlapped and arranged to form the separator overlapping portion S between the positive electrode 300 and the negative electrode 100 facing the radially inner surface of the positive electrode. In this case, the second interface S2 at which the first separator 200′ extending from the longitudinal end portion 110 of the negative electrode and the second separator 400′ extending from the longitudinal end portion 110 of the negative electrode contact each other. Through this, it is possible to more easily control the facing direction of the separators constituting the separator overlapping portion and the frictional force at the interface while allowing the separators constituting the separator overlapping portion to be include at least three layers by the simpler bending structure.

According to an exemplary embodiment of the present invention, a length of the separator overlapping portion S may be defined as an arc having an arc length of approximately 30% or more of the circumference of the electrode assembly, i.e., the separator overlapping portion S may extend approximately 108° around the electrode assembly. Specifically, the length of the separator overlapping portion may be defined as an arc length of approximately 40% or more or 50% of the circumference of the electrode assembly, i.e., the separator overlapping portion S may extend at least 144° around the electrode assembly. Said another way, the separators layers may be bent about themselves to form a separator overlapping portion S of at least a ⅓ turn or ½ turn of an inner circumferential surface of the core part of the electrode assembly.

The circumference of the electrode assembly may refer to a circumference of the inner circumferential surface of the electrode assembly, and the ‘circumference of the inner circumferential surface’ may refer to a circumference of a virtual circle having a center point in the middle of the innermost separator layer and a radius between the center point and the innermost separator layer. For example, the circumference of the inner circumferential surface of the electrode assembly may be approximately 10 mm.

In addition, referring to FIG. 3, the length of the separator overlapping portion may refer to a length of L+L′=L+L=2L. That is, the first separator extending from the longitudinal end portion of the negative electrode at the core part of the electrode assembly and the second separator extending from the longitudinal end portion of the negative electrode at the core part of the electrode assembly may be arranged in an arc that covers at least approximately ⅙ or ¼ of the circumference of the electrode assembly measured between the positive electrode and the negative electrode facing the radially inner surface of the positive electrode. The length of the separator overlapping portion may be an arc that covers approximately ⅓ or ½ of the circumference of the electrode assembly. When the length ranges are satisfied, the frictional force between the interfaces of the separators included in the separator overlapping portion can suppress the sliding of the electrode during charging and discharging of the battery, thereby preventing damage to the negative electrode and the separator when the electrode assembly contracts and expands.

According to an exemplary embodiment of the present invention, a distance between the longitudinal end portion of the separator overlapping portion and the longitudinal end portion 310 of the positive electrode 300 may be 3 mm or longer. Specifically, referring to FIG. 3, a distance L between the longitudinal end portion of the separator overlapping portion and the longitudinal end portion of the positive electrode may be 4 mm or longer, 5 mm or longer, or 6 mm or longer.

The first separator 200′ extending from the longitudinal end portion 110 of the negative electrode 100 at the core part of the electrode assembly and the second separator 400′ extending from the longitudinal end portion 110 of the negative electrode at the core part of the electrode assembly may be arranged over 3 mm beyond the longitudinal end portion 310 of the positive electrode 300 between the positive electrode 300 and the negative electrode 100 facing the radially inner surface of the positive electrode 300.

When the above-described dimensions are satisfied, even when there is a potential process error with respect to an introduction of the first separator and the second separator, the separator overlapping portion can be arranged between the positive electrode and the negative electrode facing the radially inner surface of the positive electrode. In addition, the frictional force between the interfaces of the separators can suppress the sliding of the electrode during charging and discharging of the battery, thereby sufficiently preventing damage to the negative electrode and the separator from deformation of the electrode assembly due to contraction/expansion of the electrode.

According to an exemplary embodiment of the present invention, the positive electrode 300 may include a positive electrode current collector and a positive electrode active material layer provided on the positive electrode current collector. Specifically, referring to FIG. 3, the positive electrode 300 may include a positive electrode current collector 301 and positive electrode active material layers 302 and 303 formed on one surface or both surfaces of the positive electrode current collector 301 and including a positive electrode active material. In other words, the positive electrode active material layer is formed on a positive electrode coating portion of the positive electrode current collector, and an uncoated surface not provided with the positive electrode active material layer may be referred to as a positive electrode uncoated portion.

According to an exemplary embodiment of the present invention, the positive electrode current collector may include a positive electrode coating portion coated with a positive electrode active material and a positive electrode uncoated portion not coated with the positive electrode active material, and may further include a tab on the positive electrode uncoated portion. Specifically, the positive electrode current collector may include a positive electrode uncoated portion, and a positive electrode tab provided on the positive electrode uncoated portion.

According to an exemplary embodiment of the present invention, the electrode assembly may include a positive electrode, a separator and a negative electrode stacked and wound, and the positive electrode may include a positive electrode current collector, and a positive electrode active material layer provided on at least one surface of the positive electrode current collector and having a longitudinal end portion at the same position as the positive electrode current collector. Specifically, referring to FIG. 3 the electrode assembly may include a positive electrode 300, first and second separators 200 and 400 and a negative electrode 100 stacked and wound, and the positive electrode 300 may include a positive electrode current collector 301, and positive electrode active material layers 302 and 303 provided on at least one surface of the positive electrode current collector 301 and each having a longitudinal end portion 310 at the same radial position as the positive electrode current collector 301. Said another way, one end portion 310 of the positive electrode 300 may extend in a longitudinal direction and may define a free-edge shape. As such, an area of an extraneous uncoated portion of the positive electrode current collector can be reduced to promote cost savings, and a slitting process can be performed after forming an active material layer on an electrode, so that a roll-to-roll process including the slitting process and a winding process can be performed more efficiently.

The slitting process is a process of cutting electrodes to a certain width using a cutter. Such a width may correlate to the height of the electrode assembly.

The roll-to-roll process can refer to any process using rolls. For example, when manufacturing electrode assemblies, the electrodes and separators are provided on rolls. The electrodes and separator are fed to the winding core as they are unwound from the roll and can be wound around the winding core.

The winding process refers to a process in which the electrode and the separator are wound in the winding core. The winding core may be removed after manufacturing the electrode assembly.

According to an exemplary embodiment of the present invention, the positive electrode current collector is not particularly limited as long as it has conductivity without inducing a chemical change in the battery. Specifically, for example, for the positive electrode current collector, stainless steel, aluminum, nickel, titanium, fired carbon, aluminum or stainless steel, each of which may be surface treated with carbon, nickel, titanium, silver, or the like, or other similar materials, may be used. As such, the positive electrode current collector may be provided in the form of surface-treated stainless steel, an aluminum foil, or the like.

The positive electrode current collector may typically have a thickness of 3 to 50 μm, and a surface of the current collector may be formed with microscopic irregularities to enhance adhesion of the positive electrode active material. For example, the positive electrode current collector may be used in various forms such as a film, a sheet, a foil, a net, a porous body, a foamed body, and a non-woven fabric body.

According to an exemplary embodiment of the present invention, the positive electrode active material may be a variety of materials. Specifically, the positive electrode active material may be a layered compound such as a lithium cobalt oxide (LiCoO₂) and a lithium nickel oxide (LiNiO₂), or a compound substituted with one or more transition metals; a lithium iron oxide such as LiFe₃O₄; a lithium manganese oxide such as chemical formula Li₁₊ₓMn₂₋ₓO₄ (0≤x≤0.33), LiMnO₃, LiMn₂O₃ and LiMnO₂; a lithium copper oxide (Li₂CuO₂); a vanadium oxide such as LiV₃O₈, V₂O₅ and Cu₂V₂O₇; Ni-site type lithium nickel oxide represented by chemical formula LiNi_{1-y}M_{y}O₂ (where M is at least one selected from the group consisting of Co, Mn, Al, Cu, Fe, Mg, B, and Ga, and satisfies 0.01≤y≤0.3); a lithium manganese composite oxide represented by chemical formula LiMn_{2-z}M_{z}O₂ (where M is at least one selected from the group consisting of Co, Ni, Fe, Cr, Zn and Ta, and satisfies 0.01≤z≤0.1) or Li₂Mn₃MO₈ (where M is at least one selected from the group consisting of Fe, Co, Ni, Cu and Zn.); LiMn₂O₄ in which a part of Li of the chemical formula is substituted with an alkaline earth metal ion, or the like, but is not limited thereto. The positive electrode may be Li metal.

According to an exemplary embodiment of the present invention, the positive electrode active material layer may further include a positive electrode conductive material and a positive electrode binder. The positive electrode conductive material imparts conductivity to the electrode, and can be used without limitation as long as it does not cause a chemical change while conducting electricity in a battery. Specific examples of the positive electrode conductive material may include graphite such as natural graphite or artificial graphite; a carbon-based material such as carbon black, acetylene black, Ketjen black, channel black, furnace black, lamp black, thermal black, and carbon fiber; metal powders or metal fibers such as copper, nickel, aluminum and silver; a conductive whisker such as zinc oxide and potassium titanate; a conductive metal oxide such as titanium oxide; or a conductive polymer such as polyphenylene derivative. Other materials similar to the foregoing, as well as any combination of such materials, may be used as the positive electrode conductive material.

The positive electrode binder serves to improve attachment between particles of the positive electrode active material and adhesive force between the positive electrode active material and the positive electrode current collector. Specific examples may include polyvinylidene fluoride (PVDF), vinylidene fluoride-hexafluoropropylene copolymer (PVDF-co-HFP), polyvinyl alcohol, polyacrylonitrile, carboxymethylcellulose (CMC), starch, hydroxypropylcellulose, regenerated cellulose, polyvinylpyrrolidone, tetrafluoroethylene, polyethylene, polypropylene, ethylene-propylene-diene polymer (EPDM), sulfonated-EPDM, styrene butadiene rubber (SBR), fluoro rubber, or various copolymers thereof, and the like, and any one thereof or a mixture of two or more thereof may be used.

According to an exemplary embodiment of the present invention, the negative electrode may include a negative electrode current collector and a negative electrode active material layer provided on the negative electrode current collector. Specifically, referring to FIG. 3, the negative electrode 100 may include a negative electrode current collector 101 and negative electrode active material layers 102 and 103 formed on one surface or both surfaces of the negative electrode current collector 101 and including a negative electrode active material. Said another way, the negative electrode active material layer is formed on a negative electrode coating portion of the negative electrode current collector, and an uncoated surface not provided with the negative electrode active material layer may be referred to as a negative electrode uncoated portion.

According to an exemplary embodiment of the present invention, the negative electrode current collector may include a negative electrode coated portion formed with a negative electrode active material layer and a negative electrode uncoated portion not formed with the negative electrode active material layer, and may include a tab on the negative electrode uncoated portion. Specifically, the negative electrode current collector may include a negative electrode uncoated portion, and a negative electrode tab provided on the negative electrode uncoated portion. Accordingly, the manufactured electrode assembly may include one or more negative electrode tabs.

According to an exemplary embodiment of the present invention, the negative electrode active material layer may include a negative electrode active material including at least one material selected from the group consisting of a silicon-based material and a carbon-based material. In addition, the negative electrode active material layer may further include a negative electrode conductive material and a negative electrode binder, and for the negative electrode active material, the negative electrode conductive material, and the negative electrode binder may be made from materials known in the art.

According to an exemplary embodiment of the present invention, a material for the negative electrode current collector is not particularly limited as long as it conducts electricity without causing a chemical change in the battery. For example, for the negative electrode current collector, materials such as copper, stainless steel, aluminum, nickel, titanium, fired carbon, aluminum or stainless steel each surface treated with carbon, nickel, titanium, silver, or the like, may be used. Specifically, transition metals that adsorb carbon well, such as copper and nickel, may be used for the negative electrode current collector. A thickness of the negative electrode current collector may be 6 μm or more and 80 μm or less. However, the thickness of the negative electrode current collector is not limited thereto.

According to an exemplary embodiment of the present invention, the negative electrode binder may include at least one selected from the group consisting of polyvinylidene fluoride-hexafluoropropylene copolymer (PVDF-co-HFP), polyvinylidene fluoride, polyacrylonitrile, polymethylmethacrylate, polyvinyl alcohol, carboxymethylcellulose (CMC), starch, hydroxypropylcellulose, regenerated cellulose, polyvinylpyrrolidone, tetrafluoroethylene, polyethylene, polypropylene, polyacrylic acid, ethylene-propylene-diene monomer (EPDM), sulfonated EPDM, styrene butadiene rubber (SBR), fluoro rubber, poly acrylic acid, and the above-mentioned materials in which a hydrogen is substituted with Li, Na, Ca, etc., and may also include various copolymers thereof.

According to an exemplary embodiment of the present invention, a material for the negative electrode conductive material is not particularly limited as long as it conducts electricity without causing a chemical change in the battery. For example, graphite such as natural graphite or artificial graphite; carbon black such as acetylene black, Ketjen black, channel black, furnace black, lamp black, and thermal black; a conductive fiber such as a carbon fiber and a metal fiber; a conductive tube such as a carbon nanotube; metal powders such as fluorocarbon, aluminum, and nickel powder; a conductive whisker such as zinc oxide and potassium titanate; a conductive metal oxide such as titanium oxide; a conductive material such as polyphenylene derivative, and the like may be used as the negative electrode conductive material.

An exemplary embodiment of the present invention provides a secondary battery including the jelly-roll type electrode assembly described herein, and a battery case for accommodating the electrode assembly. Specifically, the secondary battery may include the electrode assembly according to an exemplary embodiment described above and a battery case for accommodating the electrode assembly.

The secondary battery according to the present invention includes the separator overlapping portion where the bending structure of the separator of the core part and the friction coefficient between the interfaces are controlled, so that even if the electrode assembly becomes deformed due to contraction/expansion of the electrode during charging and discharging of the battery, an internal short between the positive electrode and the negative electrode can be prevented. Thus, such an electrode assembly improves the secondary battery's stability and lifespan.

According to an exemplary embodiment of the present invention, a battery case may have a cylindrical shape. Specifically, the battery case may have a cylindrical, prismatic, or pouch shape depending on particular applications. A cylindrical battery case may be more suitable for accommodating a jelly-roll type electrode assembly. When the battery case has a cylindrical shape, a shape of a secondary battery including the jelly-roll type electrode assembly and a battery case for accommodating the electrode assembly may have a corresponding cylindrical shape.

According to an exemplary embodiment of the present invention, the battery case may include an electrolyte therein. Specifically, the electrolyte may include an organic liquid electrolyte, an inorganic liquid electrolyte, a solid polymer electrolyte, a gel-type polymer electrolyte, a solid inorganic electrolyte, a molten-type inorganic electrolyte that may be used in the manufacturing of the lithium secondary battery, and the like. Specifically, the electrolyte may include a non-aqueous organic solvent and a metal salt.

According to an exemplary embodiment of the present invention, the non-aqueous organic solvent may be an aprotic organic solvent such as N-methyl-2-pyrrolidinone, propylene carbonate, ethylene carbonate, butylene carbonate, dimethyl carbonate, diethyl carbonate, gamma-butyllolactone, 1,2-dimetoxy ethane, tetrahydrofuran, 2-methyltetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivative, sulfolane, methyl sulfolane, 1,3-dimethyl-2-imidazolidinone, propylene carbonate derivative, tetrahydrofuran derivative, ether, methyl propionate, or ethyl propionate may be used.

According to an exemplary embodiment of the present invention, a lithium salt may be used as the metal salt, and the lithium salt may be a material that is readily soluble in the non-aqueous electrolyte solution. An anion of the lithium sale may be one or more species selected from the group consisting of F⁻, Cl⁻, I⁻, NO₃⁻, N(CN)²⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

According to an exemplary embodiment of the present invention, one or more additives, for example, a haloalkylene carbonate-based compound such as difluoroethylene carbonate, pyridine, triethylphosphite, triethanolamine, cyclic ether, ethylenediamine, n-glyme, hexaphosphoric triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further included in the electrolyte for the improving the lifespan of the battery, increasing battery capacity, improving discharge capacity of the battery, and the like, in addition to the advantages of the above-described electrolyte components.

Below, Examples will be described in detail to specifically describe the present invention. However, the Examples according to the present invention may be modified in other forms, and the scope of the present invention is not construed as being limited to the following Examples. The Examples of the present specification are provided to more completely explain the present invention to one skilled in the art.

### EXAMPLES

### Example 1

### Preparation of Electrode Assembly

A positive electrode was provided having a thickness of 154 μm. The electrode was prepared by preparing an A1 foil having a thickness of 15 μm and a length of 63.9 mm in the width direction as a positive electrode current collector. A positive electrode active material slurry including an NMCA (Ni—Mn—Co—Al) composite having a Ni content of 92% or more as a positive electrode active material and CNTs as a conductive material were applied to the positive electrode current collector and allowed to dry to form a positive electrode active material layer.

Next, a negative electrode was provided having a thickness of 187 μm. The electrode was prepared by preparing a Cu foil having a thickness of 8 μm and a length of 65.1 mm in the width direction as a negative electrode current collectorA negative electrode active material slurry including artificial graphite and natural graphite as negative electrode active materials in 50 parts by weight, respectively, was applied to the negative electrode current collector and was allowed to dry to form a negative electrode active material layer.

Two separators each having a coating layer including Al₂O₃ as an inorganic component, a PVdF-based binder as a binder component, and a lithium salt formed on one surface of a sheet-like polyethylene base layer were prepared as the first separator and the second separator, respectively.

Before winding a jelly-roll type electrode assembly, the base layers of the first separator and the second separator were overlapped such that the first and second base layers face each toher, and the first separator and the second separator were arranged such that an overlapping portion, in which the first and second base layers face each other, extends long enough to wrap approximately three rotations around a winding core of an electrode assembly. These three rotations extend in a direction opposite a “winding direction,” the “winding direction” being the direction the separators and electrodes are wound extending outward from a central core, rather than inward toward the central core. In the electrode assembly of FIG. 1, the winding direction is counterclockwise. The winding core may be a core of the jelly-roll electrode assembly with an outer circumference of approximately 10 mm.

After the first separator and the second separator have been wound approximately three turns toward the central core C, the separators may be folded back over themselves to extend in the winding direction to start winding. The negative electrode and the positive electrode were sequentially introduced within the first and second separators with the negative electrode being introduced first, i.e., closer to the central core C, to prepare a jelly-roll type electrode assembly. The core part of the jelly-roll type electrode assembly was formed to have a structure shown in FIGS. 1 and 2 by interposing the clockwise extending extensions of the first separator and the second separator between the second separator positioned on one surface of the positive electrode in the direction of the winding axis, i.e., counterclockwise direction, and on one surface of the negative electrode to provide a separator overlapping portion. The spacing distance L between the longitudinal end portion of the separator overlapping portion and the longitudinal end portion of the positive electrode was 3 mm, and the length (L+L′=2L), in the longitudinal direction, of the separator overlapping portion was 6 mm. The circumference of the inner circumferential surface of the prepared jelly-roll type electrode assembly was approximately 10 mm.

### Preparation of Secondary Battery

A secondary battery was prepared by inserting the jelly-roll type electrode assembly into a cylindrical battery case, injecting an electrolyte solution in which ethylene carbonate (EC), dimethyl carbonate (DMC), and ethyl methyl carbonate (EMC) were mixed at a weight ratio of 4:9:3 and LiPF₆ was dissolved to be 15 wt % into the battery case, and sealing the cylindrical battery case with a cap assembly.

### Example 2

A jelly-roll type electrode assembly and a secondary battery were prepared in the same manner as in Example 1, except that two separators each having a coating layer including Al₂O₃ as an inorganic component, a PVdF-based binder as a binder component, and a lithium salt and formed on both surfaces of a sheet-like polyethylene base layer were used as the first separator and the second separator.

### Example 3

A jelly-roll type electrode assembly and a secondary battery were prepared in the same manner as in Example 1, except that two separators in which a coating layer was not formed on both surfaces of a sheet-like polyethylene base layer were used as the first separator and the second separator.

### Example 4

A jelly-roll type electrode assembly and a secondary battery were prepared in the same manner as in Example 1, except that the spacing distance L between the longitudinal end portion of the separator overlapping portion and the longitudinal end portion of the positive electrode was 1.5 mm and the length (L+L′=2L), in the longitudinal direction, of the separator overlapping portion was 3 mm.

### Comparative Example 1

A jelly-roll type electrode assembly and a secondary battery were prepared in the same manner as in Example 1, except that the separator overlapping portion was not provided.

### EXPERIMENTAL EXAMPLES

### Experimental Example 1—Friction Coefficient Evaluation

The friction coefficients (μ) between the coating layers, between the coating layer and the base layer, and between the base layers of the first separator and the second separator were measured in accordance with the ASTM D 1894 standard. After measuring the friction coefficient in a dry method, the same specimen was immersed in the electrolyte solution for 60 minutes, and then the friction coefficient was remeasured using a wet method, and the result is shown in Table 1 below.

TABLE 1

| | Facing direction of separators | | |
|---|---|---|---|
| | coating layer - | base layer - | coating layer - |
| | coating layer | base layer | base layer |
| friction coefficient | 0.68 | 0.41 | 0.44 |
| (dry) | | | |
| friction coefficient | 0.81 | 0.45 | 0.44 |
| (wet) | | | |

Referring to Table 1, it was confirmed that the friction coefficient between the coating layer and the coating layer of the first separator and the second separator had a larger value than the friction coefficient between the base layer and the base layer or between the coating layer and the base layer. In addition, it was confirmed that the friction coefficient measured in the wet state had a larger value than the friction coefficient measured in the dry state. Specifically, it was confirmed that the friction coefficient between the base layer and the base layer had a relatively low value as compared with the friction coefficient between the coating layer and the base layer, but in a wet state, which exists internally within secondary batteries, the friction coefficient between the base layer and the base layer had a larger value. Through this, it can be seen that, when the electrode assembly is immersed in distilled water or electrolyte solution, the friction coefficient between the coating layer and the coating layer and the friction coefficient between the base layer and the base layer of the first separator and the second separator had larger values than the friction coefficient between the coating layer and the base layer. Thus, it can be seen that the friction coefficient between the interfaces of the separators included in the separator overlapping portion can be controlled within a specific range by controlling the facing direction of the coating layers provided on one surface of each of the first separator and the second separator.

### Experimental Example 2—Core Impingement Evaluation

### Short-Term Cycle Stability Evaluation

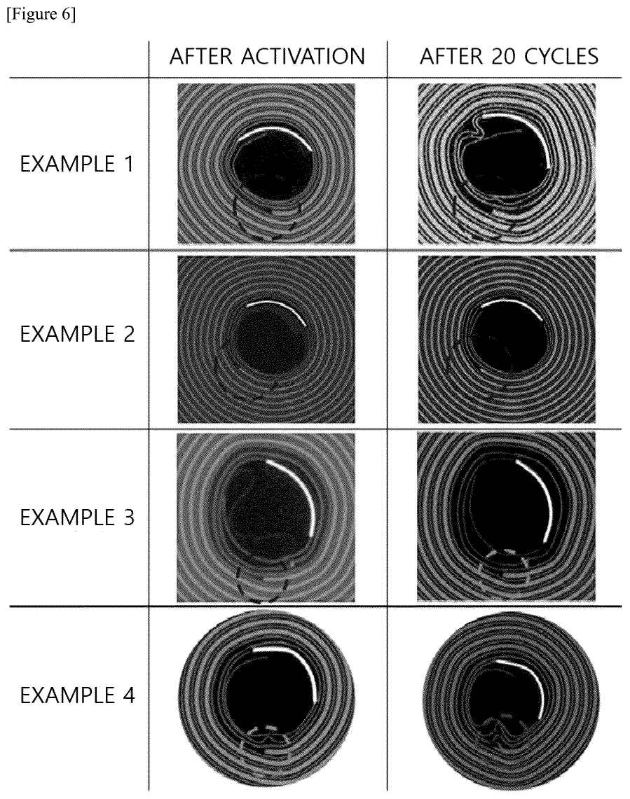

The secondary batteries prepared in Examples 1 to 4 and Comparative Example 1 were subjected to 2 cycles of 4.2 V−2.5 V, 0.2 C charging, and 0.2 C discharging, respectively, leading to preparation of activated secondary batteries. Thereafter, each of the activated secondary batteries was subjected to 20 cycles under conditions of 4.3 V−2.5 V 1 C/1 C @25° C. Then, for the short-term cycle stability evaluation, the core parts of the prepared secondary batteries were subjected to computed tomography (CT) to check the core impingement. The Images are shown in FIGS. 4 and 6, respectively.

### Long-Term Cycle Stability Evaluation

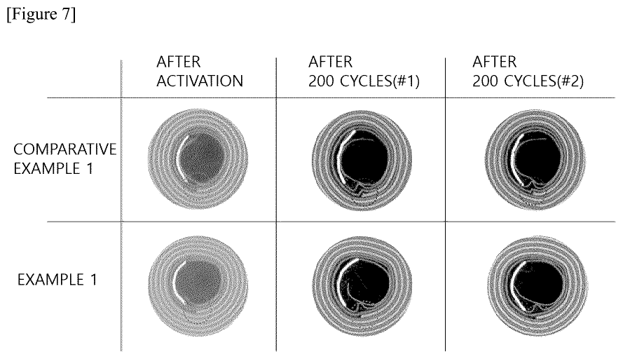

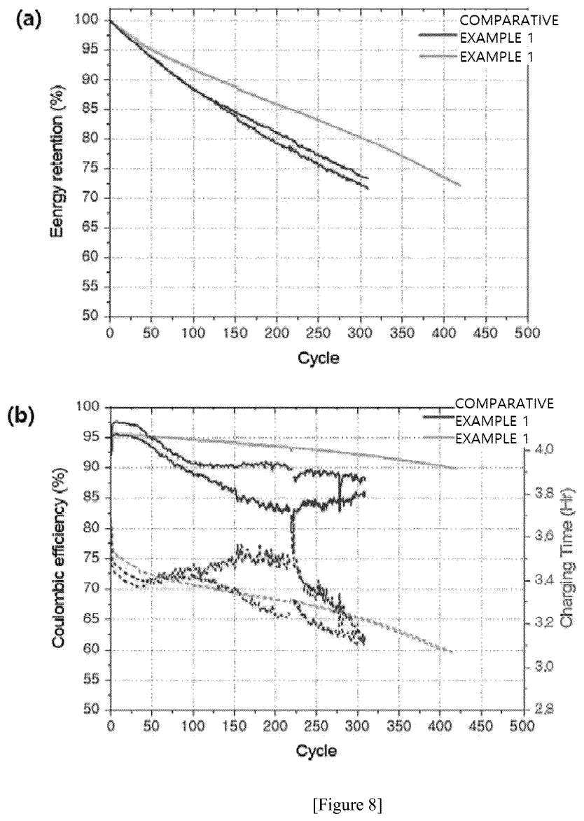

The secondary batteries prepared in Example 1 and Comparative Example 1 were subjected to 2 cycles of 4.2 V−2.5 V, 0.2 C charging, and 0.2 C discharging, respectively, leading to preparation of activated secondary batteries. Thereafter, each of the activated secondary batteries was subjected to 200 cycles under conditions of 4.25 V(0.3 C)−2.85 V(0.5 C) @55° C. Then, for the long-term cycle stability evaluation, the core parts were subjected to computed tomography (CT) to check for core impingement. The resulting CT images are shown in FIG. 7. In addition to core impingement, energy density, capacity retention rate, and coulombic efficiency according to cycle progress were measured, and the results are shown in Table 2 below and in FIG. 8.

TABLE 2

| | Comparative Example 1 | | Example 1 | |
|---|---|---|---|---|
| Energy Density | 18.8 | 18.6 | 18.7 | 18.9 |
| (Wh) | 18.7 | | 18.8 | |
| Capacity | 71.7 | 73.3 | 79.8 | 73.3 |
| retention rate | (@309cyc) | (@309cyc) | (@309cyc) | (@309cyc) |
| (%) | 79.8 | | 72.5 | |
| Coulombic | 88.0 | | 92.0 | |
| efficiency (%) | | | | |

### Core Impingement Evaluation

Whether core impingement has occurred was evaluated for the secondary batteries of Example 1 and Comparative Example 1 by the following method.

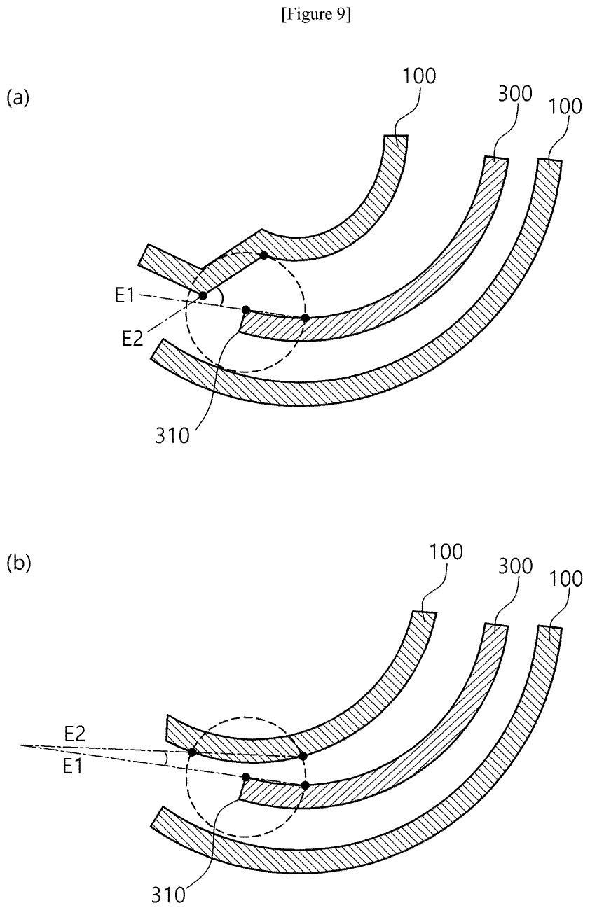

FIG. 9 schematically shows a method for evaluating whether core impingement has occurred. Specifically, FIG. 9(a) schematically shows a method for evaluating whether the core impingement has occurred when deformation occurred in the negative electrode, and FIG. 9(b) schematically shows a method for evaluating whether core impingement has occurred when deformation did not occur in the negative electrode.

1) On the radially inner surface of the positive electrode 300, a first extension line E1 is drawn by extending a straight line connecting the longitudinal end portion 310 of the positive electrode and a point 5 mm spaced from the end portion.

2-1) When the negative electrode is deformed

At the core part of the jelly-roll type electrode assembly, on the surface of the negative electrode 100 facing the radially inner surface of the positive electrode, a second extension line E2 is drawn by extending a straight line connecting two points where a direction of curvature changes within a spacing distance of 5 mm from the longitudinal end portion 310 of the positive electrode.

2-2) When there is no deformation in the negative electrode

At the core part of the jelly-roll type electrode assembly, on the surface of the negative electrode 100 facing the radially inner surface of the positive electrode, a second extension line E2 is drawn by extending a straight line connecting two points 5 mm spaced from the longitudinal end portion 310 of the positive electrode.

3) When an angle from the first extension line E1 to the second extension line E2 in a counterclockwise direction with respect to the intersection of the first extension line E1 and the second extension line E2 exceeds 25°, it was evaluated that core impingement occurred.

On the contrary, when an unknown secondary battery (unknown cell) is acquired, the above method for evaluating whether the core impingement has occurred may be applied in a manner of evaluating whether the core impingement has occurred at the time of initial acquisition, reevaluating whether the core impingement has occurred after a number of cycles, such as every 250 cycles, and comparing and analyzing the result with the core impingement conditions of the secondary battery of the exemplary embodiment according to the present invention.

FIG. 4 is a CT image showing the results of the short-term cycle stability evaluation of the secondary batteries according to Example 1 and Comparative Example 1, and FIG. 7 is a CT image showing the results of the long-term cycle stability evaluation of the secondary batteries according to Example 1 and Comparative Example 1.

Referring to FIGS. 4 and 7, it was confirmed that no core impingement occurred in both the short-term cycle stability evaluation and the long-term cycle stability evaluation of the secondary battery prepared in Example 1, but that core impingement occurred in both the short-term cycle stability evaluation and the long-term cycle stability evaluation of the secondary battery prepared in Comparative Example 1. Specifically, regarding the secondary battery prepared in Comparative Example 1, it was confirmed that core impingement did not occur in the secondary battery before activation, but that core impingement occurred in some parts of the secondary battery after activation. Furthermore, after 20 cycles, which is considered a short-term cycle, and 200 cycles, which is considered a long-term cycle, it was confirmed that the frequency and degree of damage to the negative electrode and separator by the longitudinal end portion of the positive electrode, i.e., core impingement due to contraction/expansion of the electrode assembly, considerably increased.

FIG. 6 is a CT image showing results of short-term cycle stability evaluation for secondary batteries according to Examples 1 to 4.

Referring to FIG. 6, it was confirmed that no core impingement occurred in all the secondary batteries prepared in Examples 1 to 4 after activation. However, in the case of Example 3 in which the first separator and the second separator were not provided with a coating layer, it was confirmed that after an acceleration cycle, slight bending of the negative electrode facing an outer surface of the positive electrode occurred. In the case of Example 4 in which the separator overlapping portion was less than 6 mm, it was confirmed that after activation, slight bending of the negative electrode facing the outer surface of the positive electrode occurred, and core impingement occurred after the acceleration cycle.

Through this, it can be seen that when there is a coating layer provided on at least one surface of each of the first separator and the second separator, a greater friction coefficient can be realized and implemented to prevent damage to the negative electrode and the separator during contraction/expansion of the electrode by suppressing the sliding of the electrode. Such a process can be compared with an electrode assembly having a separator overlapping portion that does not include a coating layer, i.e., the base layer and the base layer are in contact with each other at both the first interface and the second interface. Furthermore, it can be seen that when the length of the separator overlapping portion is maintained withing the ranges disclosed herein, the electrode assembly is further prevented from damage due to contraction/expansion of the electrode.

FIG. 8 is a graph showing results of long-term cycle stability evaluation for secondary batteries according to Example 1 and Comparative Example 1. Specifically, FIG. 8(a) is a graph showing capacity retention rates according to cycle progress of the secondary batteries according to Example 1 and Comparative Example 1, and FIG. 8(b) is a graph showing coulombic efficiency according to the cycle progress of the secondary batteries according to Example 1 and Comparative Example 1.

Referring to Table 2 and FIG. 8, it was confirmed that although the secondary battery according to Example 1 was provided with the separator overlapping portion for core impingement improvement, it exhibited an initial energy density and capacity retention rate similar to those of the comparative example in which the separator overlapping portion was not provided. On the other hand, in the case of the secondary battery according to Comparative Example 1, it was confirmed that the capacity retention rate decreased after an initial 50 cycles, i.e., when the long-term cycle progressed. Specifically, it was confirmed that, after 50 cycles, the coulombic efficiency reversed, as compared with the secondary battery according to Example 1, and that the lifespan decreased due to an internal short resulting from a large fluctuation width.

Through this, it can be seen that, in the case of the secondary battery according to Example 1, when the separator overlapping portion is provided, a significant decrease in the initial energy density and capacity retention rate does not occur, the battery stability and lifespan improve, as compared with the secondary battery of Comparative Example 1 which lacks a separator overlapping portion.

Thus, it can be seen that the jelly-roll type electrode assembly according to an exemplary embodiment of the present invention includes the separator overlapping portion having separators that are overlapped in three or more layers at a specific location, suppresses sliding of the electrode during charging and discharging of the battery and prevents damage to the negative electrode and the separator from deformation of the electrode assembly due to contraction/expansion of the electrode. In addition, it can be seen that even if the separator becomes damaged, the separator overlapping portion can prevent an internal short between the positive electrode and the negative electrode, thus improving the battery stability and lifespan. Furthermore, it can be seen that the above-mentioned advantageous effects can be further improved when a bending structure of the separators within a core of the electrode assembly, the friction coefficient between various interfaces of the electrode assembly, and the length range of the separator overlapping portion are controlled.

The foregoing detailed description is intended to illustrate and explain the present invention. In addition, the foregoing description is discloses embodiments of the present invention, and as described above, the present invention can be used in various other combinations, changes and environments, and can be changed and modified within the scope of the concept of the invention disclosed in the present specification, within the scope equivalent to the above disclosure, and/or within the scope of skill or knowledge in the art. Accordingly, the foregoing detailed description of the invention is not intended to limit the invention to the disclosed embodiments. Also, the appended claims should be construed to include additional embodiments.

### IDENTIFICATION OF SELECT REFERENCE NUMERALS AND SYMBOLS

100: negative electrode
101: negative electrode current collector
102, 103: negative electrode active material layer
110: longitudinal end portion of negative electrode
200, 200′: first separator
210: longitudinal end portion of first separator
201, 201′: first separator base layer
202, 202′: first separator coating layer
300: positive electrode
301: positive electrode current collector
302, 303: positive electrode active material layer
310: longitudinal end portion of positive electrode
400, 400′: second separator
410: longitudinal end portion of second separator
401, 401′: second separator base layer
402, 402′: second separator coating layer
B: bend point
S separator overlapping portion
S1: first interface
S2: second interface
Sa: one circumferential end
Sb: opposing circumferential end
L, L′: spacing distance between longitudinal end portion of separator overlapping portion and longitudinal end portion of positive electrode
E1: first extension line
E2: second extension line

1. A jelly-roll electrode assembly comprising:
first and second electrodes spaced apart from each other and helically arranged in a first direction around a winding axis of a central core of the assembly;
a separator overlapping portion including:
a first separator positioned adjacent an inner surface of a terminal end of the second electrode and extending in a second direction opposite the first direction toward the central core;
a second separator positioned adjacent a terminal end of the first separator and extending in the second direction opposite the first direction toward the central core; and
a loop portion in which the first and second separators are looped about each other in the central core to extend in the first direction around the first and second electrodes such that the second separator extends in both the first and second directions within the separator overlapping portion.

2. The assembly of claim 1, wherein the first and second separators extend in the second direction between the respective terminal ends of the first and second electrodes through the separator overlapping portion.

3. The assembly of claim 2, wherein the separator overlapping portion includes three layers of separators disposed between the respective terminal ends of the first and second electrodes.

4. The assembly of claim 3, wherein two of the three layers are the first and second separators extending in the second direction from the terminal end of the second electrode and a third layer is the second separator extending in the first direction such that the second separator extending in the first direction contacts both the first electrode and the second separator extending in the second direction.

5. The assembly of claim 1, wherein the first electrode is positioned radially inward relative to the second electrode.

6. The assembly of claim 1, wherein a length of the first electrode is longer than a length of the second electrode.

7. The assembly of claim 1, wherein each of the first and second separators includes a coating layer provided on a first longitudinal surface.

8. The assembly of claim 7, wherein the coating layer includes an inorganic component, a binder component, and a lithium salt.

9. The assembly of claim 8, wherein the coating layer of the second separator extending in the first direction contacts the coating layer of the second separator extending in the second direction to form a first interface having a first coefficient of friction.

10. The assembly of claim 9, wherein each of the first and second separators includes a base layer provided on a second longitudinal surface different than the first longitudinal surface.

11. The assembly of claim 10, wherein the base layer of the second separator extending in the second direction contacts the base layer of the first separator extending in the second direction to form a second interface having a second coefficient of friction.

12. The assembly of claim 11, wherein the first coefficient of friction is greater than the second coefficient of friction.

13. The assembly of claim 11, wherein the first coefficient of friction is at least 0.6 and the second coefficient of friction is at least 0.4.

14. A method of assembling a jelly-roll electrode assembly, the method comprising:
positioning a terminal end of a first separator adjacent to an outer electrode;
looping a free end of the first separator in a first circumferential direction around a central core of the assembly such that the free end extends in a second circumferential direction away from the central core and opposite the first circumferential direction;
positioning a terminal end of a second separator adjacent the terminal end of the first separator on a radially inward side of the first separator;
looping a free end of the second separator in the first circumferential direction around the central core such that the free end extends in a second circumferential direction opposite the first circumferential direction and away from the central core;
passing the free end of first separator in the second circumferential direction around a radially inward side of an inner electrode; and
passing the free end of the second separator in the second circumferential direction around a radially outward side of the inner electrode such that the second separator extending in the second circumferential direction is adjacent the second separator extending in the first circumferential direction.

15. The method of claim 14, wherein the looping steps include looping the free ends of the respective first and second separators clockwise in the first circumferential direction around the central core and counterclockwise in the second circumferential direction away from the central core.

16. The method of claim 14, wherein the passing the free end of the second separator step includes passing the free end of the second separator in the second circumferential direction to form a separator overlapping portion between the inner and outer electrodes, the separator overlapping portion including at least three layers of separators.

17. The method of claim 14, further comprising passing the at least three layers of separators past a longitudinal end of the inner electrode on the radially outward side of the inner electrode.

18. The method of claim 14, further comprising extending the first separator in the second circumferential direction past the longitudinal end of the outer electrode on a radially outward side of the outer electrode.

19. The method of claim 14, further comprising placing the assembly within a battery assembly.

20. A jelly-roll electrode assembly comprising:
positive and negative electrodes; and
a separator overlapping portion including a first separator positioned adjacent a second separator and extending in at least three layers in a first direction toward a core of the electrode assembly between an inner surface of the positive electrode and an outer surface of the negative electrode, the separator overlapping portion defining a first interface in which the second separator extending in the first direction and the second separator extending in a second direction opposite the first direction contact each other, and defining a second interface in which the second separator extending in the first direction and the first separator extending in the first contact each other.

21. The assembly of claim 20, wherein the separator overlapping portion includes at least three layers of separators.

22. The assembly of claim 20, wherein the first interface and the second interface each have a friction coefficient of at least 0.4.

23. The assembly of claim 20, wherein the friction coefficient of the first interface is at least 0.6.

24. The assembly of claim 23, wherein the first and second separators each include a respective coating layer provided on at least one of a respective inner and outer surface of the first and second separators.

25. The assembly of claim 24, wherein a friction coefficient of the coating layer is higher than a friction coefficient of an uncoated portion of at least one of inner and outer surfaces of the first and second separators.

26. The assembly of claim 24, wherein the coating layer includes an inorganic component, a binder component, and a lithium salt.

27. The assembly of claim 24, wherein the first interface is defined between the coating layer of the second separator extending in the first direction and the coating layer of the second separator extending in the second direction such that each coating layer at the first interface directly contacts the other.

28. The assembly of claim 24, wherein the second interface is defined between an uncoated surface of the second separator and an uncoated surface of the first separator such that each uncoated layer at the second interface directly contacts the other.
